(19) United States
(12) Patent Application Publication
(10) Pub. No.: US 2005/0172131 A1
(43) Pub. Date: Aug. 4, 2005

(54) Message conversion method and message conversion system

(76) Inventors: Kojiro Nakayama, Yokohama (JP); Naotaka Kumagawa, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/956,086

(22) Filed: Oct. 4, 2004

(30) Foreign Application Priority Data
Feb. 3, 2004 (JP) 2004-026505

(51) Int. Cl. H04L 9/00

(52) U.S. Cl. 713/176

(57) ABSTRACT

A message given with an electronic signature is modified, for example, by adding or deleting data to or from the message, while keeping validity of the electronic signature.

A conversion information insertion unit 21 of a computer B 20 receives a message given with an electronic signature from a computer A 10, and inserts conversion information into the message. Then, the conversion information insertion unit 21 sends the message added with the conversion rules to a computer C 30. A signature verification unit 31 of a computer C 30 receives the message with the inserted conversion information from the computer B 20. With respect to the received message, the signature verification unit 31 verifies whether the XML signature given by the computer A 10 is valid or not. In the case where the XML signature is valid, a conversion information application unit 32 modifies the message given with the XML signature, for example by adding or deleting data.

### BACKGROUND OF THE INVENTION

The present invention relates to a technique of converting a message added with an electronic signature.

When a plurality of computers exchanges a message through a network, an electronic signature (digital signature) is used for ensuring validity of the message. An electronic signature is signature information encrypted using a public key cryptosystem to prove a sender of the message and to prove that the message is not altered.

Further, an XML document described in XML (Extensible Markup Language) is used as a standard data format for exchanging a message between a plurality of computers. XML is one of markup languages, and recommended by a standardization body W3C (World Wide Web Consortium). W3C recommends the XML signature that prescribes a method of affixing a signature to any digital data including an XML document W3C, “XML-Signature Syntax and Processing”, [online], Feb. 12, 2002 [browsed on Jul. 27, 2003], Internet <See URL: http://www.w3.org/TR/xmldsig-core/>.

When a computer sends a message added with an electronic signature, sometimes the message passes through another computer than a computer of the last receiver. Namely, first, a sender computer sends a message added with an electronic signature to a relay computer. Receiving the message added with the electronic signature from the sender computer, the relay computer transfers the message to a last receiver computer. Here, sometimes, the relay computer modifies the message added with the electronic signature before transferring the message to the last receiver computer. In that case, the last receiver computer can not verify the validity of the electronic signature added by the sender computer. In other words, the last receiver computer can not verify that the message has been sent from the sender computer and has not been altered.

Thus, the conventional XML signature technique requires that a sender computer grasps a message part that may be altered by a relay computer and excludes that message part from an object of its signature. Further, in the case where a message is added with an electronic signature, a relay computer can not alter the message added with the electronic signature while keeping the validity of the electronic signature.

### SUMMARY OF THE INVENTION

The present invention has been made taking the above situation into consideration. An object of the present invention is to make it possible to alter a message, for example by adding or deleting data, while keeping validity of an electronic signature.

To attain the above object, the present invention inserts message conversion information at one part other than a signature object part of a message to generate a converted message.

For example, a processing unit of an information processing apparatus executes: an acquisition step in which a message given with an electronic signature is acquired from an external system; a specifying step in which an electronic signature object part of said message is specified based on information relating to the electronic signature, with said information being described in said message; a read step in which conversion information for converting said message according to predetermined rules is read from said storage unit of the information processing apparatus; and a generation step in which said conversion information is inserted into one part of said message except for the electronic signature object part specified in said specifying step to generate a converted message into which said conversion information has been inserted.

According to the present invention, it is possible to modify (for example, adds or delete data to or from) a message given with an electronic signature, while keeping validity of the electronic signature.

### BRIEF DESCRIPTION OF THE DRAWINGS

FIG. 1 is a general block diagram showing a message conversion system to which a first embodiment of the present invention is applied;

FIG. 2 is a block diagram showing an example of a hardware configuration of each computer;

FIG. 3 is a diagram showing an outline of processing in a message conversion system;

FIG. 4 shows an example of a message sent from a computer A;

FIG. 5 shows an example of conversion information of a computer B;

FIG. 6 is a diagram showing a processing flow of the computer B;

FIG. 7 shows an example of a send message of the computer B;

FIG. 8 is a diagram showing a processing flow of a computer C;

FIG. 9 is a diagram showing an example of a message after application of conversion information by the computer C;

FIG. 10 is a general block diagram showing a message conversion system to which a second embodiment of the present invention is applied;

FIG. 11 shows an example of an input screen of the computer B;

FIG. 12 is a diagram showing a processing flow of the computer B;

FIG. 13 is a diagram showing an example of a valid signature list (at generation) of the computer C;

FIG. 14 is a diagram showing a processing flow of the computer C;

FIG. 15 is a diagram showing an example of a valid signature list (after update) of the computer C; and

FIG. 16 shows an example of an output screen of the computer C.

### DESCRIPTION OF THE PREFERRED EMBODIMENTS

Now, a first embodiment of the present invention will be described.

The present embodiment will be described taking an example of message exchange using SOAP (Simple Object Access Protocol). SOAP is a protocol based on XML and used for accessing data existing in another apparatus. Namely, in message exchange according to SOAP, a lower protocol such as HTTP is used to send or receive an SOAP message which is an XML document described in XML. However, the present invention is not limited to an SOAP message, and a message of another format may be used. For example, the present invention can be applied to a message of another structured document (such as an HTML document, an SGML document, or the like) other than an XML document. Further, in the present embodiment, description will be given taking an example of an XML signature. However, the present invention is not limited to an XML signature, and can use another electronic signature.

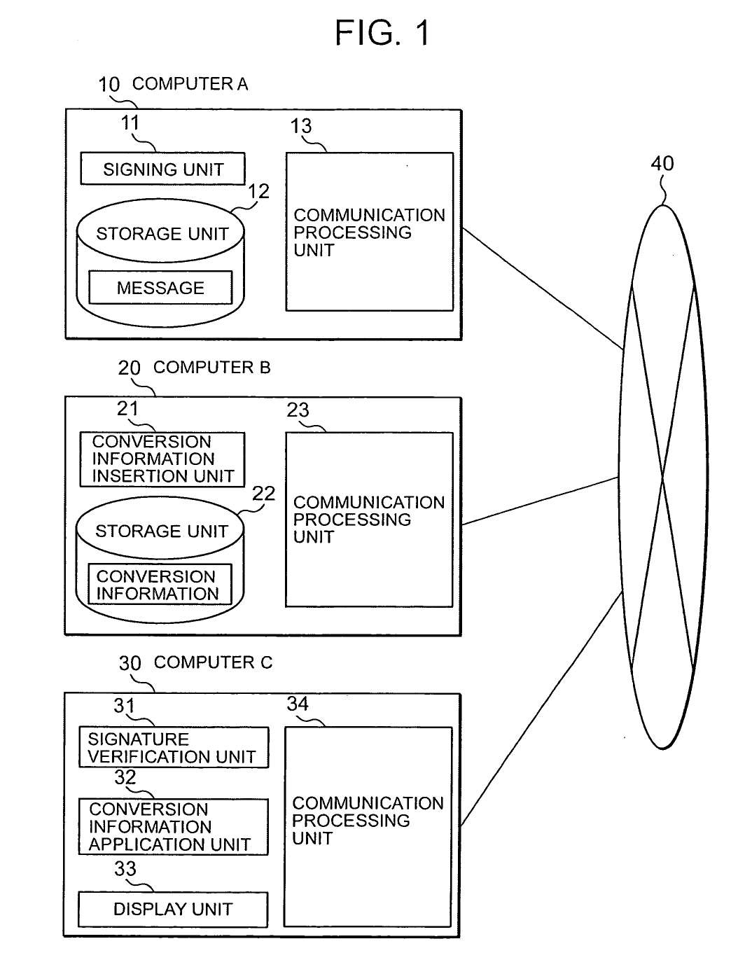

FIG. 1 is a general block diagram showing a message conversion system to which the first embodiment of the present invention is applied. As shown in the figure, the message conversion system of the present embodiment comprises a computer A 10, a computer B 20 and a computer C 30, each computer being connected with another through a network 40 such as Internet.

The computer A 10 sends an SOAP message (hereinafter, referred to as a message) added with an XML signature to the computer C through the computer B 20. The computer A 10 comprises a signing unit 11 which adds a signature to a message, a storage unit 12 which stores a message, i.e., an XML document, and a communication processing unit 13 which sends or receives a message to and from another apparatus through the network 40. It is assumed that a message stored in the storage unit 12 has been stored in advance into the storage unit 12 through an input device (not shown).

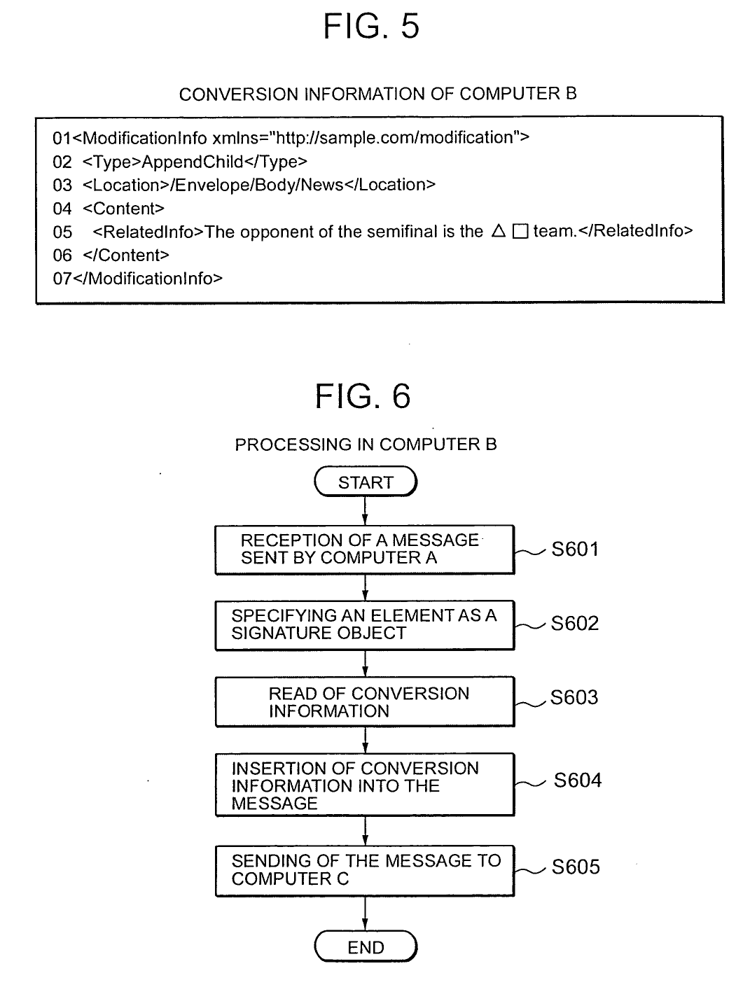

The computer B 20 adds or deletes information to or from a message received from the computer A 10 and then transfers (relays) the message to the computer C 30. The computer B20 comprises a conversion information insertion unit 21 which inserts the below-mentioned conversion information into a message received from the computer A 10, a storage unit 22 which stores the conversion information, and a communication processing unit 23 which sends or receives a message to and from another apparatus through the network 40. The conversion information is information used for instructing addition or deletion of information to or from a received message and will be described later referring to FIG. 5. Further, it is assumed that conversion information stored in the storage unit 22 has been stored in advance into the storage unit 22 through an input device (not shown).

The computer C 30 receives a message that is sent from the computer A 10 through the computer B 20. The computer C 30 comprises a signature verification unit 31 which verifies validity of an XML signature added to a received message, a conversion information application unit 32 which applies conversion information inserted by the computer B 20 to a message, a display unit 33 which outputs error information to an output device, and a communication processing unit 34 which sends or receives a message to or from another apparatus through the network 40.

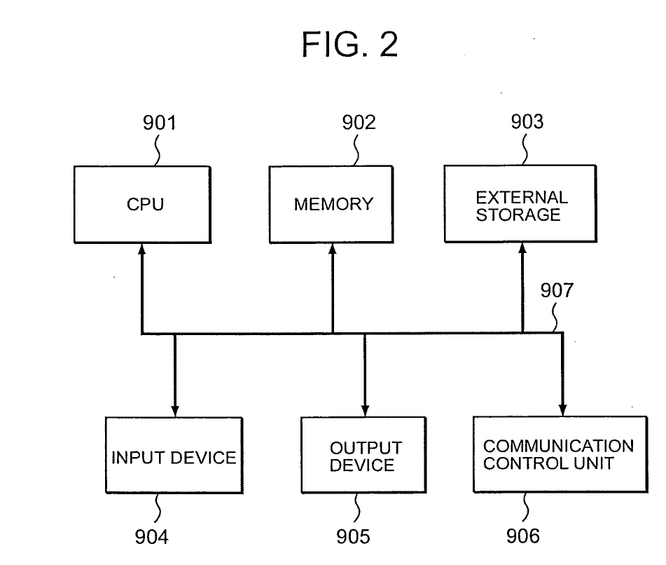

As each of the above-described computer A 10, computer B 20 and computer C 30, can be used, for example, a general purpose computer system as shown in FIG. 2 comprising a CPU 901, a memory 902, an external storage 903 such as a HDD, an input device 904 such as a keyboard or a mouse, an output device 905 such as a monitor or a printer, a communication control unit 906, and a bus 907 which connects the mentioned components with one another. In such a computer system, each function of each apparatus is realized when the CPU 901 executes a certain program loaded onto the memory 902.

For example, each function of the computer A 10, the computer B 20 or the computer C 30 is realized when the CPU 901 of the computer A 10 executes a program for the computer A 10, the CPU 901 of the computer B 20 a program for the computer B 20, or the CPU 901 of the computer C 30 a program for the computer C 30. Further, as the storage unit 12 of the computer A 10, is used the memory 902 or the external storage 903 of the computer A 10. And, as the storage unit 22 of the computer B 20, is used the memory 902 or the external storage 903 of the computer B 20. The computers A and B may not have an input device 902 or an output device. Further, the computer C may not have an input device.

Next, an outline of processing in the message conversion system as a whole will be described.

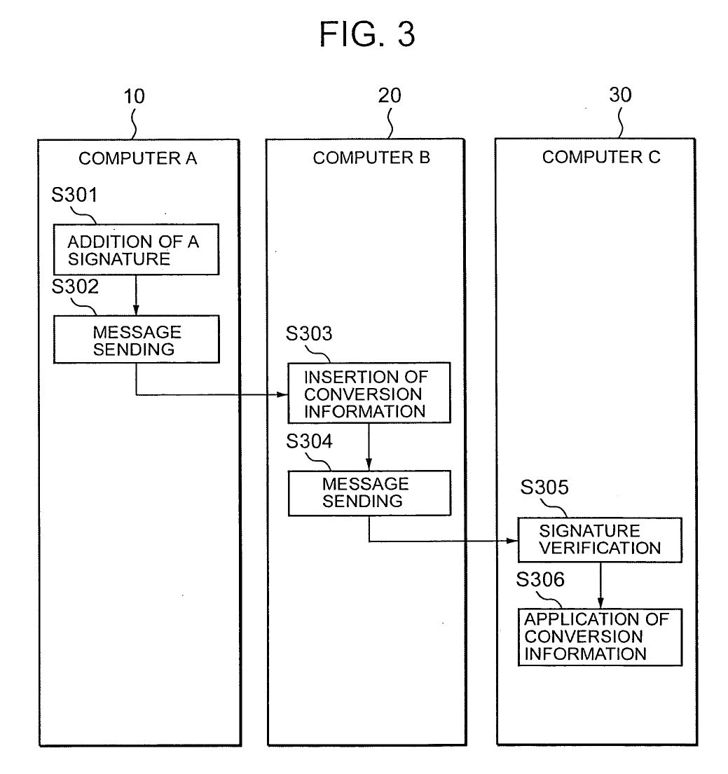

FIG. 3 is a flowchart showing an outline of the processing in the present system. First, the signing unit 11 of the computer A 10 adds an XML signature to a message which is an XML document stored in the storage unit 12 (S301). Then, the signing unit 11 uses the communication processing unit 13 to sends the message added with the XML signature to the computer B 20 (S302).

The conversion information insertion unit 21 of the computer B 20 receives the message added with the XML signature from the computer A 10 through the communication processing unit 23, and inserts conversion information into the message (S303). Then, the conversion information insertion unit 21 sends the message with the inserted conversion rules to the computer C 30 through the communication processing unit 23 (S304).

The signature verification unit 31 of the computer C 30 receives the message with the inserted conversion information from the computer B 20 through the communication processing unit 34. Then, with respect to the received message, the signature verification unit 31 verifies whether the XML signature added by the computer A 10 is valid or not (S305). In the case where the XML signature is valid, then, based on the conversion information, the conversion information application unit 32 modifies (for example, adds or deletes data to or from) the message added with the XML signature (S306).

Next, will be described a message added with an XML signature.

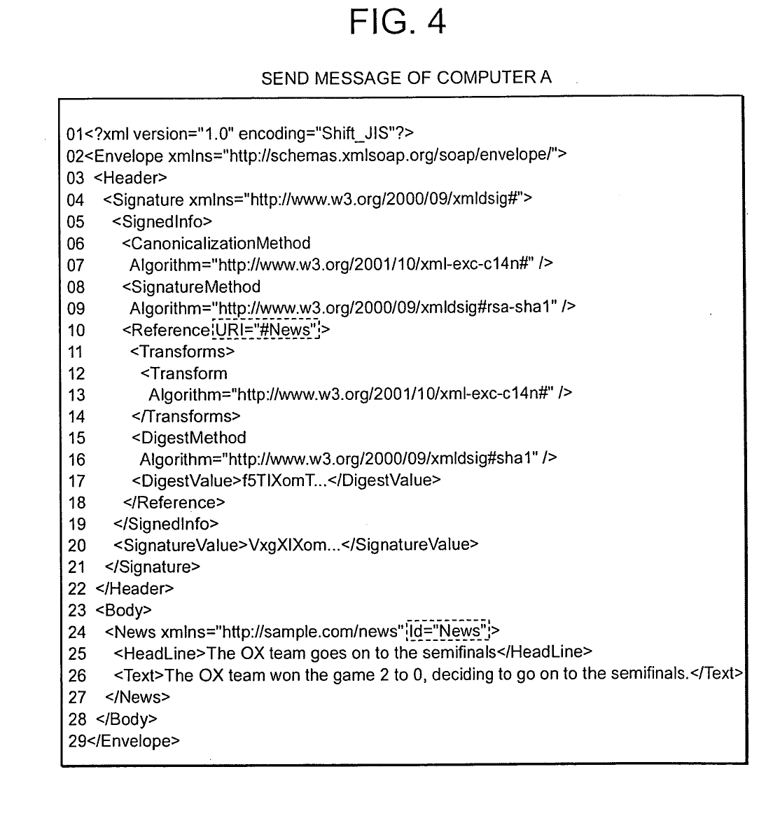

FIG. 4 shows an example of a message resulting from addition of an XML signature by the signing unit 12 of the computer A 10 to a message stored in the storage unit 12. Here, for the sake of easiness of explanation, the message shown in the figure is given with line numbers (two-digit numbers each shown in the beginning of a line), although an actual message does not include such numbers.

As shown in the figure, the message has an Envelope element (line numbers 02-29) as a route element. The Envelope element servers as an envelope that encloses a whole SOAP message, and has a Header element (line numbers 02-22) and a Body element (line numbers 23-28) as child elements.

The Header element is an element for describing information relating to message management, and can be omitted. In the example shown in FIG. 4, the Header element has a Signature element (line numbers 04-21) as a child element for describing information relating to an XML signature. The Signature element has a SignedInfo element (line numbers 05-19) and a SignatureValue element (line number 20) as child elements. The SignedInfo element has CanonicalizationMethod element (line numbers 06 and 07) designating a URL of a normalization algorithm, SignatureMethod element (line numbers 08 and 09) designating a URL of an encryption algorithm and Reference (line numbers 10-18) designating an object of the XML signature. The SignatureValue element (line number 20) is set with an encrypted value.

In the example shown in FIG. 4, “URI=“#News” ” (line number 10) described in Reference indicates the object of the XML signature. Namely, the object of the XML signature is an element whose Id attribute has a value “News”. Here, a News element (line numbers 24-27), i.e., a child element of the below-mentioned Body element has an Id attribute “News” (line number 24). Thus, it is shown that the object of the XML signature is the News element. In the case where the object of the XML element is the entire message, then Reference describes “URI=“ ””.

The Body element is an element for describing contents of the message to be sent, and an indispensable component of the Envelope element. In the example shown in FIG. 4, the Body element has the News element (line numbers 24-27) as a child element. As described above, the News element (line numbers 24-27) has the Id attribute set with the value “News”. Further, the News element has child elements, a Headline element (line number 25) set with a value “The ◯X team goes on to the semifinals” and a Text element (line number 26) set with a value “The ◯×team won the game 2 to 0, deciding to go on to the semifinals.”

The storage unit 12 of the computer A 10 stores the message before addition of the XML signature. Namely, the storage unit 12 of the computer A 10 stores the message without the Header element (line number 02-22) shown in FIG. 4. Further, when the News element as the object of the XML signature is modified after the XML signature is added to the message (i.e., after a SignatureValue is obtained), the validity of the XML signature is lost. In other words, it becomes impossible to verify that the message has not been altered.

Next, will be described the conversion information stored in the storage unit 22 of the computer B 20. The conversion information describes a modification operation such as addition or deletion of information to or from a message added with an XML signature, clearly and uniquely according to a predetermined definition method and rules.

FIG. 5 shows an example of conversion information. In the example shown in the figure, the conversion information has a ModificationInfo element (line numbers 01-07) as a route element. The ModificationInfo element has a Type element (line number 02), a Location element (line number 03) and a Content element (line numbers 04-06) as child elements. The Type element (line number 02) describes a type (such as “AppendChild” (addition of a child element), “Delete” (deletion of an element) or the like, for example) of an operation applied to a message added with an XML signature. The Type element “AppendChild” means addition of a content of the Content element to the tail (the end) of an element described in the Location element, as a child element of the element in question. The Type element “Delete” means deletion of an element described in the Location element. In the case where the Type element describes “Delete”, then the Content element can be omitted. Further, it is considered that the Type element describes a type other than “AppendChild” and “Delete”. For example, the Type element may describe an operation type (“SetAttribute”) that means addition of an attribute to an element described in the Location element.

The Location element (line number 03) describes a node as an object of an operation. The object of the operation is described in a path (i.e., a character string indicating a location of an element) expressed from the route element of the message through the node as the object of the operation, using “/” as a delimiter. In the example of the Location element shown in FIG. 5, the object of the operation is the child element (the News element) of the child element (the Body element) of the route element of the message shown in FIG. 4. In the case where the Type element is “AppendChild”, a node as the object of the operation should be an element node. On the other hand, in the case where the Type element is “Delete”, a node as the object of the operation does not need to be an element node, and can be described using, for example, “text( )” which expresses a text node.

When the operation type described in the Type element is “AppendChild” (addition of a child element), the Content element (line numbers 04-06) describes a child element to be added. The child element described in the Content element is added to the tail (the end) of the element that the Location element describes as the operation object. The example of the conversion information of FIG. 5 indicates that “<RelatedInfo>The opponent of the semifinal is the Δ□ team.</Relatedlnfo>” is added to the tail of the News element, as a child element of the News element as the object of the operation.

In the present embodiment, the conversion information is described according to the above-described definition method and rules. However, the present invention is not limited to this. The conversion information can be described using other definition method and rules as far as the definition method and rules can clearly and uniquely describe an operation on a message which is sent and received between a plurality of computers.

Next, processing in the computer B 20 will be described.

FIG. 6 is a flowchart showing a flow of processing in the computer B 20. First, the conversion information insertion unit 21 of the computer B 20 receives a message (See FIG. 4) sent from the computer A 10 through the communication processing unit 23 (S601). Then, the conversion information insertion unit 21 specifies an element as the object of the XML signature, from the received message (S602). Namely, the conversion information insertion unit 21 specifies an element whose Id attribute is the value set in “Reference URI=” in the Signature element of the message. In detail, from “Reference URI=“#News”” (FIG. 4: line number 10), the conversion information insertion unit 21 specifies the News element (line numbers 24-27).

Then, the conversion information insertion unit 21 reads the conversion information (See FIG. 5) stored in the storage unit 22 (S603). And, the conversion information insertion unit 21 inserts the read conversion information into the received message (S604). At that time, the conversion information insertion unit 21 inserts the conversion information into a place other than the element as the object of the XML signature, which has been specified in S602. For example, the conversion information insertion unit 21 inserts the conversion information at the head or tail of the Header element or at the head or tail of the Body element, as the place other than the object element of the XML signature, according to a predetermined insertion rule. Then, the conversion information insertion unit 21 sends the message with the inserted conversion information to the computer C 30 through the communication processing unit 23 (S605).

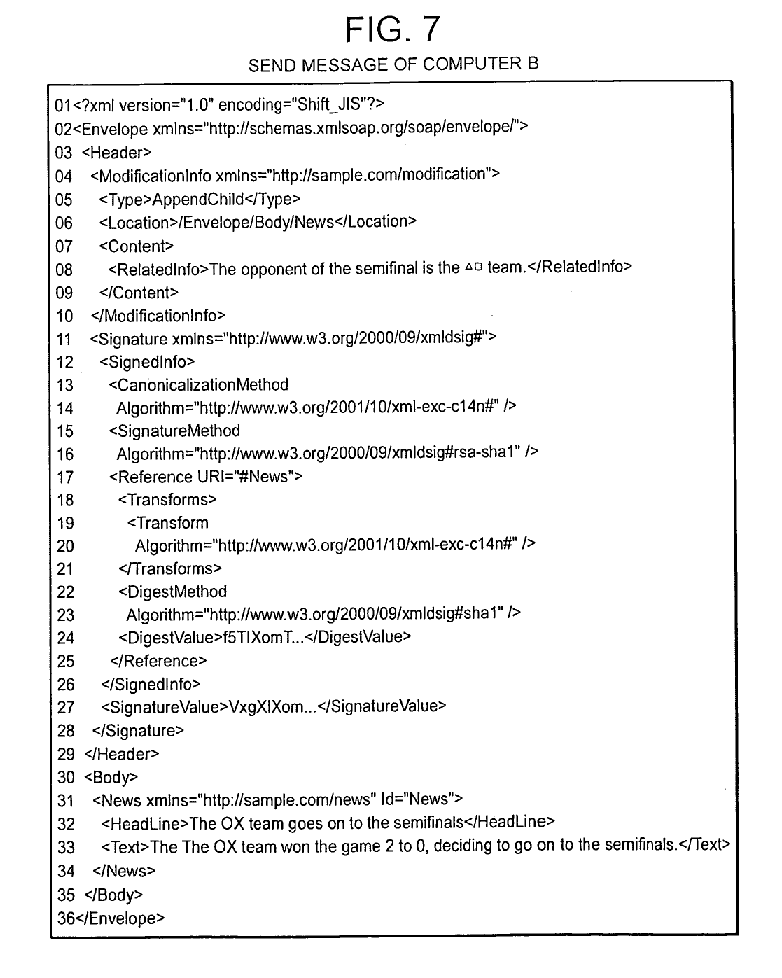

FIG. 7 shows an example of a message to which conversion information is inserted by the conversion information insertion unit 21. In the example shown, the ModificationInfo element (line numbers 04-10), i.e., the conversion information shown in FIG. 5, is inserted as the first child element of the Header element of the message.

Thus, the computer B 10 adds the conversion information to the message added with the XML signature, at a place other than the element as the object of the XML signature. As a result, the computer B 20 can add the conversion information to the message received from the computer A 10 without changing the element as the object of the XML signature. In other words, the computer B 20 can modify (for example, add or delete information in) the message while keeping the validity of the XML signature added by the computer A 10.

Next, will be described processing in the computer C 30.

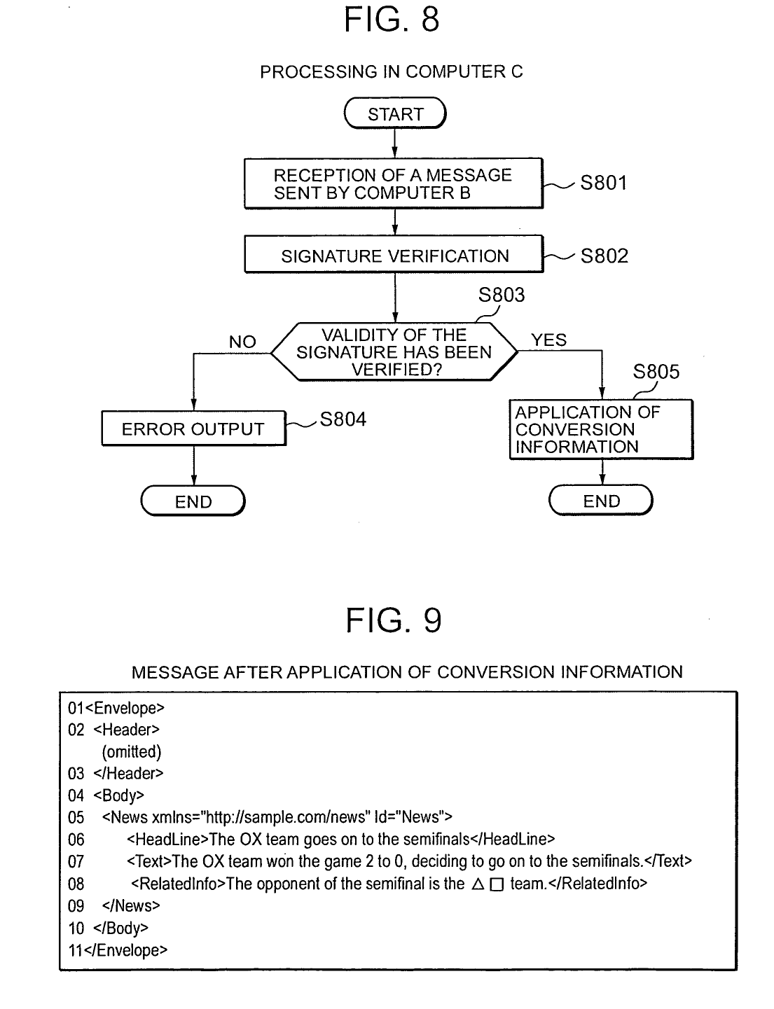

FIG. 8 is a flowchart showing a flow of processing in the computer C 30. First, the signature verification unit 31 of the computer C 30 receives a message (See FIG. 7) sent from the computer B 20 through the communication processing unit 34 (S801). Then, the signature verification unit 31 verifies the validity of an XML signature added to the received message (S802). The verification of the XML signature is same as the ordinary XML signature verification processing. Namely, the signer, i.e., the signing unit 11 of the computer A 10 uses its secret key to encrypt a predetermined signature object part of a message (an XML document) stored in the storage unit 12 to generate an XML signature, adds the generated XML signature to the message, and sends the message added with the signature. Then, the signature verification unit 31 of the computer C uses a public key of the signer to decode the XML signature added to the message, and compares the decoded result with the signature object part to verify whether the content is correct or not. Using the XML signature, it is possible to assure that the message sent from the computer A 10 has not been altered and the signer is the computer A 10.

In the case where the result of the comparison between the decoded result and the signature object part is not correct, namely, the validity of the XML signature can not be verified (S803: NO), the display unit 33 outputs error information to the output device 905 to the effect that the XML signature is not valid (S804). Here, it should be remembered that, in the present embodiment, addition of the conversion information by the conversion information insertion unit 21 of the computer B 20 is performed by inserting the conversion information into an element other than the signature object, and thus, the signature object, i.e., the News element has not been modified in any way. Thus, in the case where the conversion information insertion unit 21 has added the conversion information, the validity of the XML signature is kept and the signature verification unit 31 succeeds in verification of the XML signature.

In the case where the result of the comparison between the decoded result and the signature object part is correct, namely, the validity of the XML signature can be verified (S803: YES), the conversion information application unit 32 applies the conversion information that has been inserted in the received message to the signature object part (S805). In other words, the conversion information application unit 32 acquires the conversion information (the ModificationInfo element) included in the received message, and converts the message according to the conversion information described in the element concerned.

For example, in the case of the message shown in FIG. 7, the conversion information application unit 32 acquires the ModificationInfo element (line numbers 04-10). Namely, the conversion information application unit 32 detects the part enclosed by the tags of ModificationInfo (<ModificationInfo> . . . </ModifictionInfo>). Then, the conversion information application unit 32 refers to the operation type (AppendChild) described in the Type element in the ModificationInfo element, and adds the content (<RelatedInfo>The opponent of the semifinal is the Δ□ team.</RelatedInfo>) of the Content element as a child element of the News element (which is the operation object element described in the Location element) at the tail of the News element.

FIG. 9 shows the result of the message conversion performed by the conversion information application unit 32, applying the ModificationInfo element as the conversion information to the News element as the object of the XML signature. Here, the Header element is same as FIG. 7, and is omitted. As shown in the figure, “<RelatedInfo>The opponent of the semifinal is the Δ□ team.</RelatedInfo>” (line number 08) is added as the last child element of the News element. Here, after the conversion information application unit 32 converts the message, the display unit 33 may output the News element after the conversion to the output device 905 to display the converted message to a user of the computer C 30. Further, the conversion information application unit 32 may store the converted message in the external storage 903.

Thus, the computer C 30 verifies the validity of the XML signature and thereafter converts the received message based on the conversion information. As a result, the computer C 30 can receive the message to which the conversion information of the computer B 20 has been inserted, while keeping the validity of the XML signature added by the computer A 10. Further, the computer C can apply (reflect) the modification operation described in the conversion information to the received message to obtain data affected by the conversion information of the computer B 20.

Hereinabove, the first embodiment of the present invention has been described. According to the present embodiment, the computer B 20 can add the conversion information (relating to, for example, addition or deletion of information to or from) to a message while keeping the validity of the XML signature of the computer A 10. Further, the computer C 30 can verify the validity of the XML signature by the computer A 10 and thereafter acquire the message reflecting the conversion information added by the computer B 20.

Next, will be described a second embodiment of the present invention.

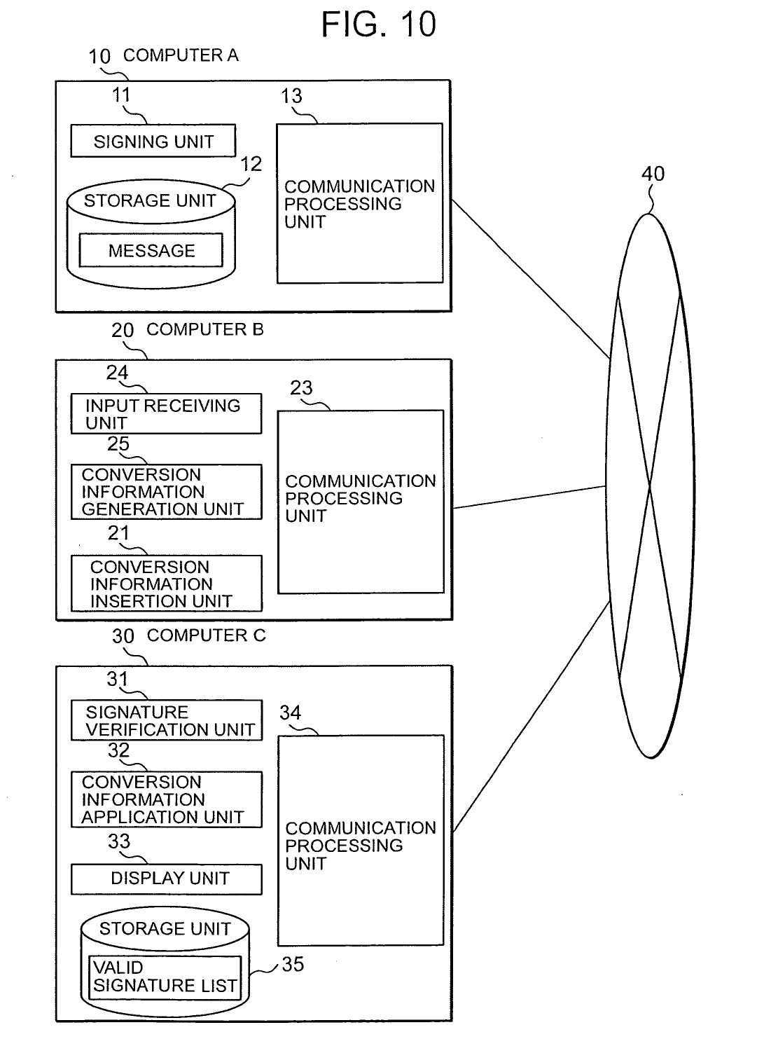

FIG. 10 is a general block diagram showing a message conversion system to which the second embodiment of the present invention is applied. As shown in the figure, the message conversion system of the present embodiment comprises a computer A 10, a computer B 20 and a computer C 30, each computer being connected with another through a network 40 such as Internet. The computer A 10 in the present embodiment has similar functions as the computer A 10 in the first embodiment shown in FIG. 1, and adds an XML signature to a message stored in a storage unit 12 and sends the message added with the signature to the computer B 20.

The computer B 20 is similar to the computer B 20 of the first embodiment, and adds or deletes information to or from a message received from the computer A 10 and then transfers (relays) the message to the computer C 30. The computer B 20 comprises an input receiving unit 24 which receives input of data from an input device 904, a conversion information generation unit 25 which generates conversion information from the inputted data, a conversion information insertion unit 21 and a communication processing unit 23. The computer B 20 in the present embodiment differs from the computer B 20 (See FIG. 1) in the first embodiment in that the computer B 20 in the present embodiment has the input receiving unit 24 and the conversion information generation unit 25. Further, the computer B 20 in the present embodiment differs from the computer B 20 in the first embodiment in that the computer B 20 in the present embodiment does not have a storage unit 22 that stores the conversion information. Except for these points, the computer B 20 in the present embodiment is similar to the computer B 20 in the first embodiment.

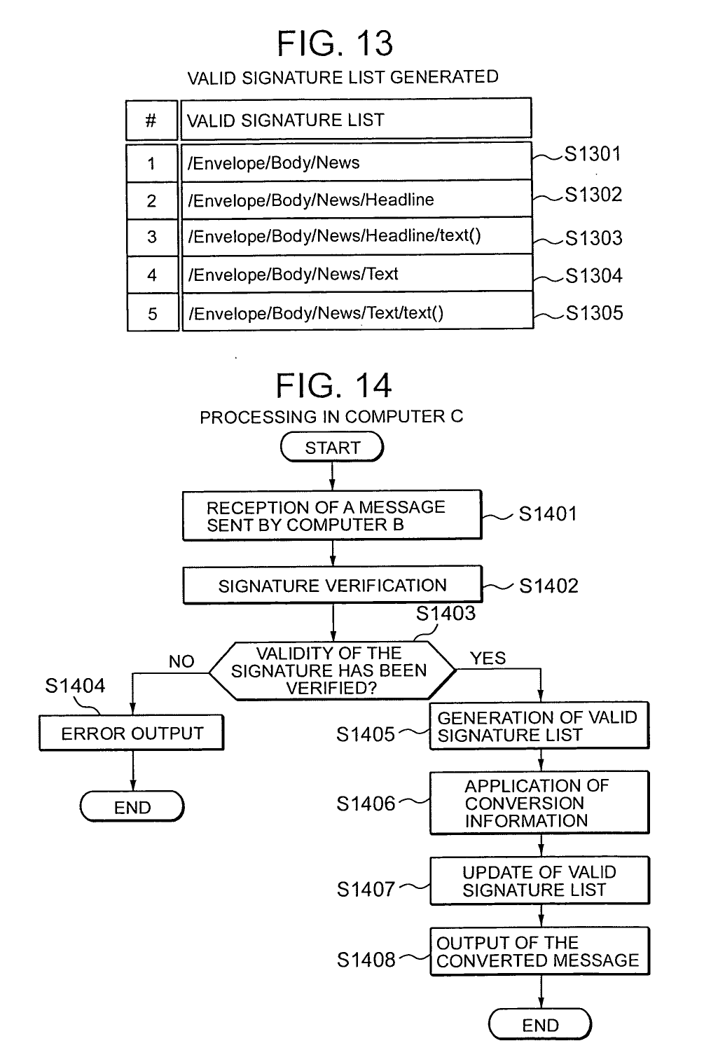

The computer C 30 is similar to the computer C 30 in the first embodiment and receives a message sent from the computer A 10 through the computer B 20. The computer C 30 comprises a signature verification unit 31, a conversion information application unit 32, a display unit 33 which displays a content of a message and error information, a communication processing unit 34, and a valid signature list 35 which stores a valid element of an XML signature. The computer C 30 in the present embodiment differs from the computer C 30 (See. FIG. 1) in the first embodiment in that the computer C 30 in the present embodiment has the valid signature list 35 and the display unit 33 displays not only error information but also a content of a message. Except for these points, the computer C 30 in the present embodiment is similar to the computer C 30 in the first embodiment. The valid signature list will be described later referring to FIG. 13.

As each of the above-described computer A 10, computer B 20 and computer C 30, can be used, for example, a general purpose computer system as shown in FIG. 2 referred to above. In this computer system, each function of each apparatus is realized when the CPU 901 executes a certain program loaded onto the memory 902. Further, as the storage unit 12 of the computer A 10, is used the memory 902 or the external storage 903 of the computer A 10. And, as the storage unit 35 of the computer C 30, is used the memory 902 or the external storage 903 of the computer C 30. The computer A may not have an input device 904 or an output device 905. Further, the computer C may not have an input device.

Next, will be described an input screen that the input receiving unit 24 of the computer B outputs to the output device 905.

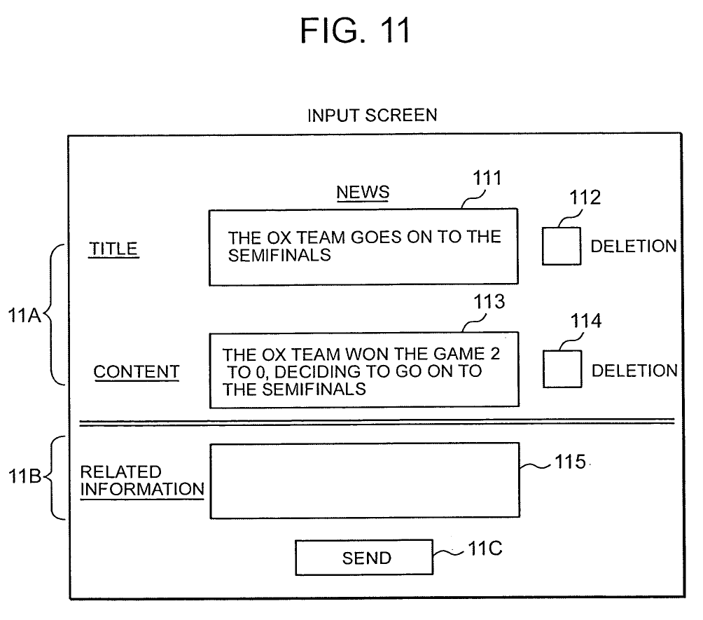

FIG. 11 shows an example of the input screen outputted to the output device 905 when the message shown in FIG. 4 is received. The input screen comprises a message display part 11A which displays a content of a message (the Body element) received, a conversion information input part 11B for inputting conversion information, and a send button 11C.

In the case of the message shown in FIG. 4, the Body element has the News element as its child element, and the News element has the Headline element and the Text element as its child elements. Thus, in the message display part 11A, the input receiving unit 24 displays the contents of the Headline element and the Text element as the child elements of the News element. In detail, in the message display part 11A, the input receiving unit 24 displays a title text box 111 which displays a text node (“The ◯X team goes on to the semifinals”) of the Headline element, a deletion check box 112 for the title text box 111, a content text box 113 which displays a text node (“The ◯X team won the game 2 to 0, deciding to go on to the semifinals.” of the Text element, and a deletion check box 114 for the content text box 113. Here, each text node indicates the content of the element concerned. Further, each deletion check box 112 or 114 is a check box which receives an instruction to delete the corresponding child element. When the input receiving unit 24 receives a deletion instruction from the input device 904, the input receiving unit 24 displays, for example, a mark “√” in a deletion check box 112 or 114 concerned.

Further, the input receiving unit 24 displays an input box 115 in the conversion information input part 11B. In the input box 115, a user of the computer B 20 inputs information that he wishes to add using the input device 904. The send button 11C is a button that the user pushes after he finishes the input. When the send button is pushed, the conversion information generation unit 25 generates conversion information based on the input screen.

Next, will be described processing in the computer B 20.

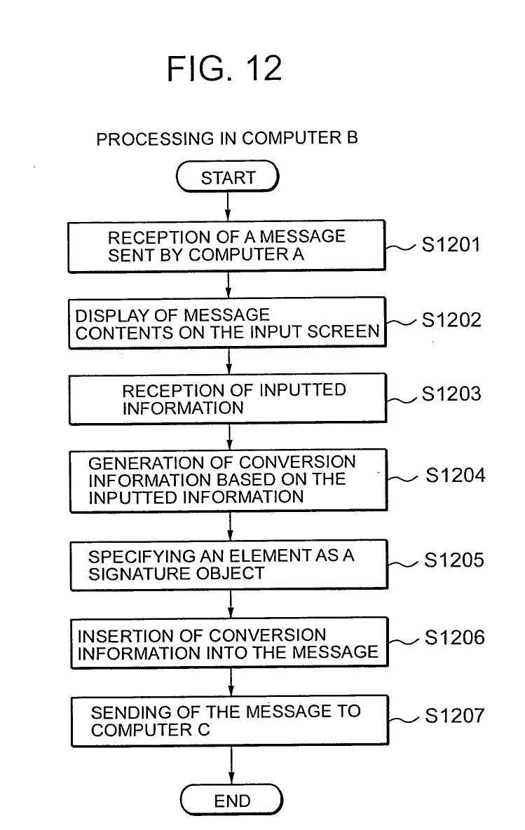

FIG. 12 is a flowchart showing a flow of processing in the computer B 20. In the following description, it is assumed that a message sent from the computer A 10 is the message shown in FIG. 4 similarly to the first embodiment. First, the input receiving unit 24 of the computer B 20 receives the message sent from the computer A 10 through the communication processing unit 23 (S1201). Then, the input receiving unit 24 displays the input screen (See FIG. 11) having the content of the Body element of the received message and the input box which inputs conversion information, to the output device 905 (S1202).

Then, the input receiving unit 24 receives input from the user (S1203). Namely, the input receiving unit 24 receives a character string that the user inputs in the input box 115 through the input device 904. Or, the input receiving unit 24 receives a deletion instruction that the user inputs in the deletion check box 112 or 114 through the input device 904. Receiving a push of the send button by the user after finishing the input into the input screen, the input receiving unit 24 delivers the information inputted by the user in the input screen is delivered to the conversion information generation unit 25.

Then, the conversion information generation unit 25 generates conversion information based on the information received by the input receiving unit 24 (S1204). For example, in the following, will be described processing in the input receiving unit 24 in the case where information “The opponent of the semifinal is the Δ□ team.” is inputted in the input box 115. In this case, the conversion information generation unit 25 generates conversion information for adding the above-mentioned information inputted in the input box 115 as related information to the received message.

First, the conversion information generation unit 25 generates a ModificationInfo element that indicates conversion information, and generates a Type element, Location element and Content element as child elements of the ModificationInfo element. Then conversion information generation unit 25 judges that the operation is addition of a child element, since the information is inputted in the input box 115, and sets “AppendChild” in the Type element. Then, in the Location element, the conversion information generation unit 25 sets a child element (i.e., a News element) of the Body element of the message. In detail, using a path, the conversion information generation unit 25 sets “/Envelope/Body/News” in the Location element. Then, the conversion information generation unit 25 adds a RelatedInfo element as a child element to the Content element. And, as a content of the RelatedInfo element, the conversion generation unit 25 sets the information (“The opponent of the semifinal is the Δ□ team.”) inputted in the input box 115. The conversion information generated by the conversion information generation unit 25 is same as the conversion information shown in FIG. 5 referred to above.

Further, in the case where, for example, the check mark indicating a deletion instruction has been inputted in a deletion check box 112 or 114 of the input screen (See FIG. 11), then the conversion information generation unit 25 sets “Delete” in the Type element. Further, in the Location element, the conversion information generation unit 25 sets the child element corresponding to the deletion box 112 or 114 in which the deletion instruction has been given, while the Content element is omitted.

As described above, the conversion generation unit 25 generates conversion information from information inputted in the input screen shown in FIG. 11. Then, the conversion information generation unit 25 delivers the generated conversion information and the message received from the computer A 10 to the conversion information insertion unit 21.

From the message received from the computer A 10, the conversion information insertion unit 21 specifies the element as the object of the XML signature (S1205). Then, the conversion information insertion unit 21 inserts the conversion information at a part other than the XML signature object element (S1206). Here, the specifying of the element as the signature object and the insertion of the conversion information (S1205 and S1206) by the conversion information insertion unit 21 are similar to the processing (FIG. 6: S602 and S604) in the first embodiment. Further, an example of the message to which the conversion information has been inserted is similar to FIG. 7 referred to above. Then, the conversion information insertion unit 21 sends the message to which the conversion information has been inserted to the computer C 30 through the communication processing unit 23 (S1207).

Next, will be described the valid signature list of the computer C 30.

The valid signature list is a list of nodes, each of which is given with a valid XML signature which, for example, has not been altered. Further, the valid signature list holds information on nodes, each of which is given with a valid signature.

FIG. 13 is a diagram showing an example of a valid signature list that is generated by the signature verification unit 31 of the computer C 30 after verification of the validity of the XML signature of the message (See FIG. 7) received from the computer B 20. The XML signature object part of the message shown in FIG. 7 is the News element as described above. Thus, the valid signature list holds information on all the nodes constituting the News element. In other words, as shown in the figure, the valid signature list has the News element (an element node) 1301, the Headline element (an element node) 1302, the content of the Headline element (a text node) 1303, the Text element (an element node) 1304, and the content of the Text element (a text node) 1305. In the example shown in FIG. 13, each node is described using a path similar to the Location element of the conversion information (See FIG. 5).

Next, will be described processing in the computer C 30.

FIG. 14 is a flowchart showing a flow of processing in the computer C 30. In the following description, it is assumed that a message sent from the computer B 20 is the message shown in FIG. 7 similarly to the first embodiment. First, the signature verification unit 31 receives a message sent from the computer B 20 through the communication processing unit 34 (S1401) and verifies the validity of the XML signature (S1402). In the case where the validity of the XML signature can not be verified (S1403: NO), the display unit display error information on the output device 905 (S1404). Hitherto, the processing is similar to the processing of the first embodiment (FIG. 8: S801-S804).

In the case where the XML signature is valid (S1403: YES), the signature verification unit 31 generates the above-mentioned valid signature list (See FIG. 13) (S1405). Namely, the signature verification unit 31 detects the element as the object of the XML signature from “Reference URI=” (FIG. 7: line number 17) of the Signature element of the received message. Then, the signature verification unit 31 reads the News element (line numbers 31-34). And, based on the tags described in the News element, the signature verification unit 31 generates the valid signature list that describes all the nodes (components) included in the News element. Then, the signature verification unit 31 stores the valid signature list in the storage unit 35.

Next, the conversion information application unit 32 applies the conversion information which has been inserted in the received message to the signature object part (S1406). This processing is similar to the processing of the first embodiment (FIG. 8: S805). Then, the conversion information application unit 32 reads the valid signature list stored in the storage unit 35, and updates the valid signature list based on the conversion information (S1407). Namely, in the case where an element as the operation object of the conversion information exists in the valid signature list, the conversion information application unit 32 deletes that element (node) as the operation object and the upper element (node) to that element from the signature object list.

For example, in the case where “AppendChild” is set in the Type element of the conversion information, a new child element will be added. Accordingly, the element set in the Location element and the upper node to that element are deleted from the valid signature list. Further, in the case where “Delete” is set in the Type element of the conversion information, the node set in the Location element and the upper node to that node are deleted from the valid signature list.

In the case of the message shown in FIG. 7, the conversion information application unit 32 adds a RelatedInfo element as a child element to the News element. Accordingly, the conversion information application unit 32 deletes the News element (an element node) 1301 as the upper element to the RelatedInfo element as the operation object from the signature object list shown in FIG. 13.

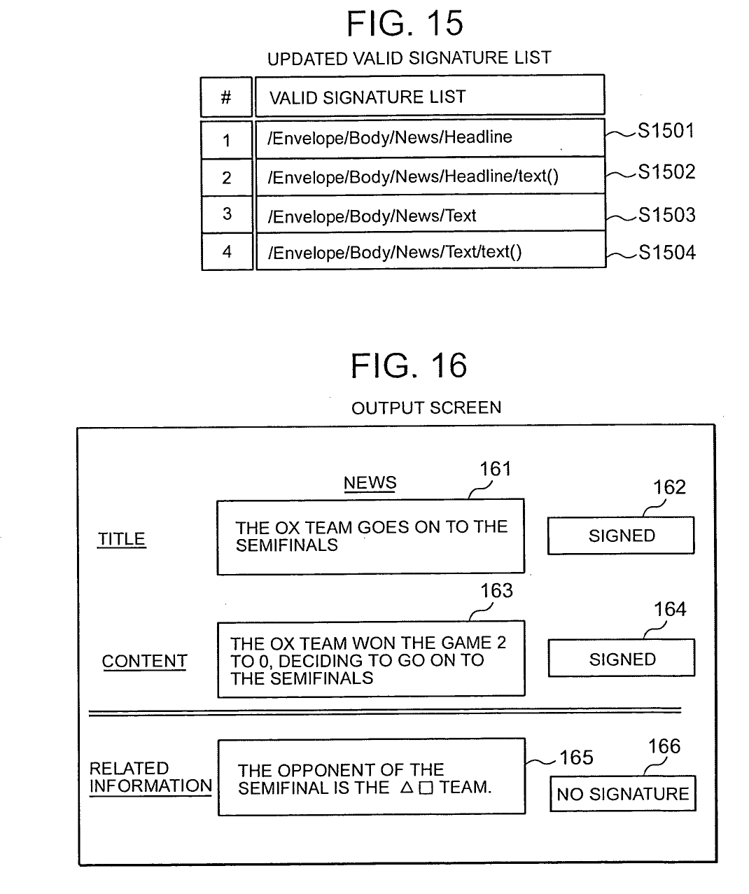

FIG. 15 shows an example of the valid signature list obtained after the conversion information application unit 32 updates the valid signature list shown in FIG. 13. As shown in the figure, after deletion of the News element (an element node), this valid signature list has the Headline element (an element node) 1501, the content of the Headline element (a text node) 1502, the Text element (an element node) 1503, and the content of the Text element (a text node) 1504. Each node of the Headline element and Text element 1501-1504 is not an operation object of the conversion information, and thus held in the valid signature list. The conversion information application unit 32 stores the updated valid signature list in the storage unit 35.

After the conversion information application unit 32 updates the valid signature list, the display unit 33 outputs the message reflecting the conversion information to the output device 905 (S1408). Namely, the display unit 33 refers to the message (See FIG. 9) reflecting the conversion information to output each element included in the message, and refers to the updated valid signature list to output signature information that indicates whether a valid XML signature is added to each element.

FIG. 16 shows an example of an output screen in the case where “The opponent of the semifinal is the Δ□ team.” is inputted in the input box 115 of the input screen shown in FIG. 11. Based on the message (See FIG. 9) reflecting the conversion information, the display unit 33 displays the child elements of the News element on the output screen, namely, the Headline element, the Text element, and the RelatedInfo element inputted through the input screen. Namely, as the Headline element, the display unit 33 displays a title text box 161 and signature information 162 indicating existence or nonexistence of the XML signature.

Further, in the title text box 161, the display unit 33 displays the content (a text node) of the Headline element of the message shown in FIG. 9. Then, the display unit 33 reads the updated valid signature list (See FIG. 15) from the storage unit 35 to judge whether the updated valid signature list stores the Headline element. Since the element node 1501 and the text node 1502 of the Headline element are stored in the valid signature list, the display unit 33 displays “Signed” in the signature information 162.

Further, as the Text element, the display unit 33 displays a content text box 163 and signature information 164. Similarly to the Headline element, the display unit 33 displays the content (a text node) of the Text element of the message shown in FIG. 9 in the content text box 163. Further, the display unit 33 reads the valid signature list and displays “Signed” in the signature information 164.

Further, as the RelatedInfo element, the display unit 33 displays an input box 164 and signature information 166. In the input box 165, the display unit 33 displays the content (a text node) of the RelatedInfo element of the message shown in FIG. 9. Further, the display unit 33 reads the updated valid signature list from the storage unit 35. Since the element node and the text node of the RelatedInfo element do not exist in the valid signature list, the display unit 33 displays “No signature” in the signature information 166.

Hereinabove, the second embodiment of the present invention has been described. According to the present embodiment, it is possible to obtain effects similar to the first embodiment.

The computer B 20 of the present embodiment receives input of information from the user through the input screen and generates the conversion information. As a result, the computer B 20 can display a message received from the computer A 10 and provide a user interface (an input screen) through which a conversion instruction to that message can be inputted. And, the user of the computer B 20 can input an instruction of conversion such as addition or deletion of any information while confirming the received message. And, the computer B 20 automatically generates the conversion information based on the information inputted by the user through the input screen. As a result, it is possible to reduce a workload at generation of conversion information.

Further, the computer C 30 of the present embodiment displays a message reflecting (applying) the conversion information together with signature information on the output device 905. As a result, the user of the computer C 30 can easily judge which part of the displayed message has a valid XML signature.

The present invention is not limited to the above-described first and second embodiments and can be varied variously within the scope of the invention.

For example, the above embodiments have been described taking the examples where a message is exchanged through a network. However, the present invention can be applied to other uses, for example, circulation of a structured document such as an XML document through a workflow.

1. A message conversion method in which an information processing apparatus converts a message, wherein:
said information processing apparatus comprises a processing unit and a storage unit; and
said processing unit executes:
an acquisition step in which a message given with an electronic signature is acquired from an external system;
a specifying step in which an electronic signature object part of said message is specified based on information relating to the electronic signature, with said information being described in said message;
a read step in which conversion information for converting said message according to predetermined rules is read from said storage unit; and
a generation step in which said conversion information is inserted into one part of said message except for the electronic signature object part specified in said specifying step to generate a converted message into which said conversion information has been inserted.

2. A message conversion method according to claim 1, wherein said processing unit executes further:
a verification step in which validity of the electronic signature given to said converted message is verified; and
a conversion step in which, when the validity of the electronic signature is verified, the message acquired in said acquisition step is converted based on said conversion information inserted into said converted message.

3. A message conversion method according to claim 1, wherein said processing unit executes further:
an instruction receiving step in which a conversion instruction to the message acquired in said acquisition step is received; and
a conversion information generation step in which the conversion information for converting said message according to the predetermined rules is generated based on said conversion instruction.

4. A message conversion method according to claim 2, wherein:
in said verification step, for each component as an electronic signature object part of said converted message, a piece of valid signature information indicating validity of an electronic signature concerned is stored in said storage unit; and
in said conversion step, after said message is converted, said piece of valid signature information for each component is read from the storage unit, and a piece of valid signature information for a component whose electronic signature has lost validity owing to conversion of said message is deleted among pieces of valid signature information for respective components, and, based on the pieces of valid signature information after said deletion for respective components, validity of an electronic signature for each component in the converted message is outputted to an output device.

5. A message conversion method according to claim 1, wherein:
said message given with an electronic signature is a structured document.

6. A message conversion program, according to which an information processing apparatus converts a message, wherein:
said information processing apparatus comprises a processing unit and a storage unit; and
said processing unit executes:
an acquisition step in which a message given with an electronic signature is acquired from an external system;
a specifying step in which an electronic signature object part of said message is specified based on information relating to the electronic signature, with said information being described in said message;
a read step in which conversion information for converting said message according to predetermined rules is read from said storage unit; and
a generation step in which said conversion information is inserted into one part of said message except for the electronic signature object part specified in said specifying step to generate a converted message into which said conversion information has been inserted.

7. A message conversion program according to claim 6, wherein:
said processing unit executes further:
a verification step in which validity of the electronic signature given to said converted message is verified; and
a conversion step in which, when the validity of the electronic signature is verified, said message is converted based on said conversion information inserted into said converted message.

8. A message conversion system in which a message is converted, wherein:
said message conversion system comprises a first information processing apparatus and a second information processing apparatus;
said first information processing apparatus comprises:
a storage means which stores conversion information used for converting a message given with an electronic signature, conversion being performed according to prescribed rules;
an acquisition means which acquires said message given with the electronic signature from an external apparatus;
a specifying means which specifies an electronic signature object part of said message based on information relating to the electronic signature, with said information being described in said message;
a generation means which inserts the conversion information stored in said storage means into one part of said message except for the electronic signature object part specified by said specifying means, to generate a converted message into which said conversion information has been inserted; and
a communication means which sends said converted message generated by the generation means to said second information processing apparatus; and
said second information processing apparatus comprises:
a receiving means which receives the converted message sent by said first information processing apparatus;
a verification means which verifies validity of the electronic signature given to said converted message; and
a conversion means which converts the message acquired by the acquisition means of the first information processing means, based on the conversion information inserted into said converted message, when the validity of the electronic signature is verified.
